(19) United States
(12) Patent Application Publication
(10) Pub. No.: US 2021/0357785 A1
(43) Pub. Date: Nov. 18, 2021

(54) PREDICTIVE ANALYTICS SYSTEM AND METHOD FOR IMPLEMENTING MACHINE LEARNING MODELS INTO PREDICTION SYSTEMS

(71) Applicants: Ruma Mukherjee, Bangalore (IN); Kamisetty Yamini Preethi, Bangalore (IN); Mohammed Shafi Tarafdar, Bangalore (IN); Poopesh Kumar Thangavel, Bangalore (IN)

(72) Inventors: Ruma Mukherjee, Bangalore (IN); Kamisetty Yamini Preethi, Bangalore (IN); Mohammed Shafi Tarafdar, Bangalore (IN); Poopesh Kumar Thangavel, Bangalore (IN)

(73) Assignee: Unisys Corporation, Blue Bell, PA (US)

(21) Appl. No.: 17/015,167

(22) Filed: Sep. 9, 2020

(30) Foreign Application Priority Data
May 12, 2020 (IN) 202011020075

(51) Int. Cl. G06N 5/04; G06N 20/00

(52) U.S. Cl. CPC G06N 5/04; G06N 20/00

(57) ABSTRACT

A production system and method for integrating machine learning models. The system includes a Model Development System having machine learning models, which perform predictions on input data received by the machine learning model. The system includes a Prediction System that receives an input message and generates prediction results based on predictions performed on input data from the received input message. The system includes at least one machine learning model adapter. The machine learning model adapter loads a corresponding machine learning model from the Model Development System, and provides input data to the loaded machine learning model, in which the input data is based on the input message received by the Prediction System. The machine learning model adapter also receives prediction value results from the loaded machine learning model based on predictions performed by the loaded machine learning model, and sends the prediction value results to the Prediction System.

### BACKGROUND

### Field

The instant disclosure relates generally to prediction systems, and in particular to integrating machine learning models into prediction systems.

### Description of the Related Art

Predictive modeling is a process that uses data mining and probability to forecast outcomes. A prediction model is made up of a number of predictors, which are variables that are likely to influence future results. Once data has been collected for relevant predictors, a statistical model, such as one or more machine learning (ML) models, is formulated and implemented into the prediction model. Machine learning models include various regression algorithms, instance-based algorithms, decision tree algorithms and other suitable algorithms and models.

Moving prediction models to production often is difficult in getting suitable value out of machine learning models implemented in the Model Development Systems. Machine learning models typically are built in Model Development Systems, which often are based on one or more analytics platforms, such as Spark, R and SAS. The output of machine learning models can be in a variety of formats, such as MLlib pipeline models, JPMML, MOJO and Python objects,

A Prediction System is a system that performs real time prediction by implementing, or consuming, machine learning models. A Prediction System typically is implemented using the Java, Python or C programming language.

Deployment or implementation of a machine learning model into a Prediction System typically requires custom implementation based on the type of machine learning model being deployed. Each time a new machine learning model with a different output format is deployed, the new machine learning model requires additional coding in the Prediction System. This additional coding typically leads to a relatively long and costly deployment cycle from development to production, and typically is a relatively significant barrier to relatively rapid deployment of a real time Production System.

Machine learning models typically are developed in a Model Development System by analyzing historical data. Historical data is analyzed to determine the data patterns and correlations to derive the machine learning models. The format in which these machine learning models are saved usually depends on the platform of the Model Development System. For example, a Spark Model Development System usually produces machine learning models in MLlib. Thus, conventionally, only an MLlib-compatible prediction system is able to load, run, understand and make use of such a machine learning model as the machine learning model is developed.

The Prediction System is a real time system that performs predictions on an input stream of messages. For each incoming message, the Prediction System invokes the developed machine learning models to determine a prediction score, i.e., one prediction score from each machine learning model deployed. Based on the output from each machine learning model, the Prediction System calculates an ensemble score. The ensemble score can be based on techniques like majority voting, weighted average, or other suitable techniques. Each type of machine learning model from different Model Development Systems performs in different ways, producing different predictions for an input message. Thus, the Prediction System leverages machine learning models from multiple Model Development Systems to perform ensemble scoring and to output a consolidated prediction score. Here, the benefit of performing ensemble scoring by a Prediction System is to capture the predictions from all types of machine learning models.

To make this work, the Prediction System should be able to load multiple machine learning models and send required message attributes (i.e., input features) to the machine learning models at runtime. All of the machine learning models deployed should be compatible with the Prediction System, irrespective of the platform used for the Model Development System.

There is a need for a system and method that allows Prediction Systems to be able to load multiple machine learning models and send required message attributes (i.e., input features) to the machine learning models at runtime, and for all of the machine learning models to be compatible with the corresponding Prediction System, irrespective of the platform used for the Model Development System.

### SUMMARY

Disclosed is a system and method for integrating machine learning models. The system includes a Model Development System having at least one machine learning model stored therein, in which the machine learning model is configured to perform predictions on input data received by the machine learning model. The system also includes a Prediction System configured to receive an input message and to generate a prediction result based on a prediction performed on input data from the received input message. The system also includes at least one machine learning model adapter coupled between the Model Development System and the Prediction System. The machine learning model adapter loads a corresponding machine learning model from the Model Development System, and provides input data to the loaded machine learning model, in which the input data is based on the input message received by the Prediction System. The machine learning model adapter also receives prediction value results from the loaded machine learning model based on predictions performed by the loaded machine learning model, and sends the prediction value results to the Prediction System,

### BRIEF DESCRIPTION OF THE DRAWINGS

FIG. 1 is a schematic view of a production system for integrating machine learning models developed by a Model Development System into a Prediction System, according to an embodiment; and

FIG. 2 is a flow diagram of a method for integrating machine learning models developed by a Model Development System into a Prediction System, according to an embodiment.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting, and merely set forth some of the many possible embodiments for the claimed invention.

Machine learning (ML) models developed using certain analytics platforms (such as Spark, R or SAS) and output in certain formats (such as JPMML, MOJO or Python) perform better than machine learning models developed using certain programming languages (such as Java or C) because of the respective run-time capabilities of these programming languages. However, most Prediction Systems are built in languages like Java and C in real-time.

Therefore, conventionally, machine learning models typically have to be recreated or rewritten in a programming language understandable by a given Prediction System. However, recreating or rewriting machine learning models in a programming language understandable by a given Prediction System typically is error-prone and inefficient. But, developing machine learning models in an environment better suited for Prediction Systems (i.e., using the same environment for development and runtime) suffers from the performance restrictions mentioned hereinabove.

According to an embodiment, a real time intelligent system is provided that dynamically integrates and uses all standard types of machine learning models through the use of pluggable adapters, as described in greater detail hereinbelow. According to an embodiment, microservices, or other suitable development technique or techniques, are used for componentization of an analytics system that is highly scalable, secure and capable of accepting real time feeds. Microservices makes a given Prediction System capable of being used with any type of end-to-end solution in Production Systems. The integration of any new machine learning model to the Production System is completely dynamic and effective through changes in a configuration file, as discussed in greater detail hereinbelow. According to an embodiment, machine learning model specific adapters and configuration files are used to achieve this flexibility.

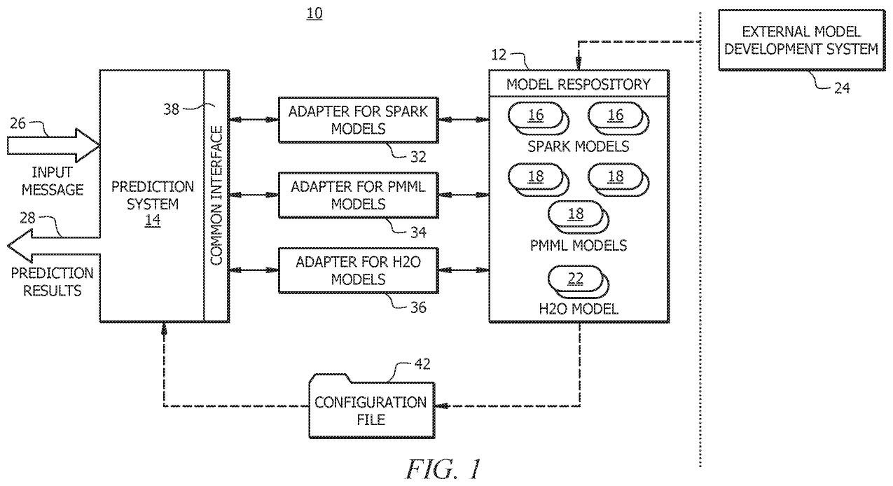

FIG. 1 is a schematic view of a Production System 10 for integrating machine learning models developed in an external Model Development System 24 into a Prediction System 14, according to an embodiment. The Prediction System 14 includes a model repository 12, where one or more machine learning models are stored. Machine learning models that are stored in the model repository include one or more Spark machine learning models 16, one or more PMML machine learning models 18, one or more H2O machine learning models 18, and/or other suitable machine learning models. Also, when one or more new machine learning models are to be integrated into the Production System 10 from an external Model Development System, the externally built machine learning model is imported into and stored in the model repository.

As discussed hereinabove, machine learning models typically are developed in the Model Development System 12 by analyzing historical data. Historical data is analyzed to determine the data patterns and correlations to derive the machine learning models. The format is which these machine learning models are saved usually depends on the platform of the Model Development System 12.

The Prediction System 14 is a microservice deployed in production to perform predictions. As discussed hereinabove, the Prediction System 14 is a real time system that performs predictions on an input message or stream of input messages 26. For each incoming message, the Prediction System 14 invokes one or more developed machine learning models from the model repository to determine or generate prediction results 28, e.g., one prediction score from each machine learning model deployed by the Prediction System 14. Based on the output from each machine learning model deployed by the Prediction System 14, the Prediction System 14 calculates an ensemble score. The ensemble score can be based on techniques like majority voting, weighted average, or other suitable techniques.

As discussed hereinabove, each type of machine learning model from the model repository within the Model Development System 12 performs in different ways, producing different predictions for a given input message where each model uses different input features from the incoming message. However, conventionally, prediction systems typically are implemented in a programming language or format (e.g., Java, Python or C) different from the framework of the machine learning models. Therefore, conventionally, the deployment or implementation of a machine learning model into a conventional prediction system typically requires custom implementation based on the type of machine learning model being deployed. In a conventional prediction system, each time a new machine learning model with a different output format is deployed, the machine learning model requires additional coding. As discussed hereinabove, this additional coding typically leads to a relatively long and costly deployment cycle from development to production, and typically is a relatively significant barrier to relatively rapid deployment of a real time production system.

According to an embodiment, the Prediction System 14 leverages multiple different machine learning models from the Model Development System 12 to perform ensemble scoring and to generate or output a consolidated prediction score. The benefit of performing ensemble scoring by the Prediction System 14 is to capture the predictions from all types of developed machine learning models selected from the model repository.

According to an embodiment, the Production System 10 includes one or more Adapters, coupled between the Model Development System 12 and the Prediction System 14, to dynamically work with the different types of machine learning models stored in the model repository. For example, the Production System 10 includes a Spark machine learning model Adapter 32 to work with Spark machine learning models, a PMML machine learning model Adapter 34 to work with PMML machine learning models, and an H2O machine learning model Adapter 36 to work with H2O machine learning models. It should be understood that, according to an embodiment, the Production System 10 can include other adapters coupled between the Model Development System 12 and the Prediction System 14 to work with other types of machine learning models that may be stored in the model repository. That is, any type of machine learning model is capable of being integrated into the Prediction System 14 as long as an appropriate adapter for the machine learning model exists within the Production System 10.

According to an embodiment, at run time, the appropriate adapter loads the corresponding machine learning model for which the adapter is configured. For example, the Spark machine learning model Adapter 32 loads the Spark machine learning model form the model repository at run time. Once the adapter has loaded the corresponding machine learning model, the adapter sends input features (i.e., data fields) received from the Prediction System 14 to the loaded machine learning model. The adapter performs predictions using the loaded machine learning model and based on the input features sent to the loaded machine learning model. The adapter receives prediction value results (i.e. output) from the loaded machine learning model. The adapter then sends the prediction value results to the Prediction System 14. It should be understood that the adapter itself is responsible for providing any necessary format compatibility with the Prediction System 14, based on the particular language in which the Prediction System 14 is built.

According to an embodiment, the Prediction System 14 includes or provides a common interface 38, The common interface 38 is implemented by all of the adapters to load models, to perform predictions using the loaded models, and to send the prediction results to the Prediction System 14. The common interface 38 includes appropriate load, predict and unload methods to allow the adapters to send prediction results from each adapter to the Prediction System 14.

As an example, the Adapter 36 for H2O MOJO machine learning models uses the Java library “hex.genmodel.MojoModel” to load an H2O MOJO machine learning model from the model repository and to perform predictions using the H2O MOJO machine learning model. The Adapter 36 then sends the resulting predictions to the Prediction System 14 via the common interface 38. As another example, the Adapter 32 for Spark MLlib machine learning models uses the Java library “org.apache.spark.ml.PipelineModel” to load a Spark MLlib machine learning model from the model repository. The Adapter 36 uses the Spark MLlib machine learning model to perform predictions, and then the Adapter 36 sends the resulting predictions to the Prediction System 14 via the common interface 38.

Therefore, according to an embodiment, each adapter works as a bridge between the Model Development System 12 (and the machine learning models exported from the model repository to the adapter) and the Prediction System 14. Model transformation logic used by each adapter depends on what kind of machine learning model the adapter is configured to implement. According to an embodiment, one adapter for each type of machine learning model is sufficient for multiple machine learning models of the same type.

According to an embodiment, the Production System 10 also includes one or more configuration files 42. The configuration file 42 is picked by the Prediction System 14 in run-time. The configuration file 42 contains configuration information about all of the available machine learning models stored in the model repository. Each time a new machine learning model is to be added into the Prediction System 14, the configuration file 42 is updated with the machine learning model configuration information in a model-specific adapter section of the configuration file 42. According to an embodiment, the Prediction System 14 monitors the configuration file 42 for changes in the configuration file 42 to use the machine learning models for predictions in run-time.

According to an embodiment, implementing machine learning models into the Production System 10 requires no changes to the Prediction System 14 other than configuration file changes/updates. No code changes to the Prediction System 14 are needed. According to an embodiment, integration of machine learning models into the Production System 10 is dynamic, and there is no compile time dependency.

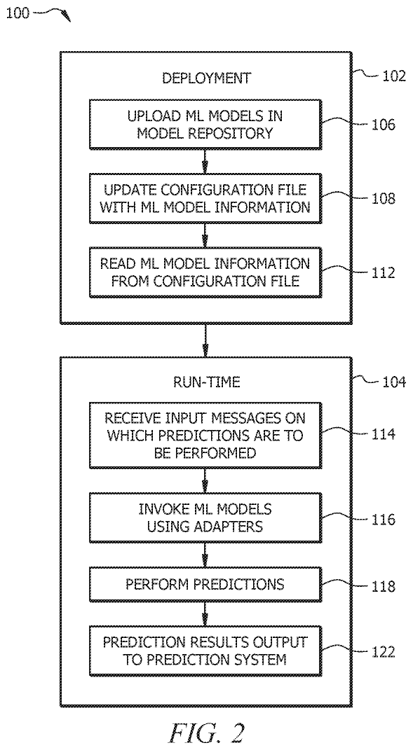

FIG. 2 is a flow diagram of a method 100 for implementing machine learning models developed by a Model Development System into a Prediction System, according to an embodiment. The method 100 includes a deployment process 102 and a run-time process 104.

The deployment process 102 includes a step 106 of uploading one or more developed machine learning models into the model repository of the Model Development System 12. The uploaded machine learning models typically are built and developed in an external machine learning model development system, such as Spark, PMML or H2O, and then uploaded into the model repository of the Model Development System 12. However, it should be understood that the machine learning models can be built and developed directly within the Model Development System 12 or its model repository.

The deployment process 102 also includes a step 108 of updating the configuration file 42. When a new machine learning model is updated into the model repository of the Model Development System 12, the Model Development System 12 updates the configuration file 42 with configuration information associated with the new machine learning model.

The deployment process 102 also includes a step 112 of reading the updated machine learning model configuration information from the updated configuration file 42. As discussed hereinabove, the Prediction System 14 monitors the configuration file 42 for changes/updates in the configuration file 42. When the configuration file has been updated with new machine learning model configuration information, the Prediction System 14 reads the new machine learning model configuration information from the updated configuration file 42. The Prediction System 14 reads the new machine learning model configuration information from the updated configuration file 42 to use the new machine learning model to perform predictions (via a machine learning model adapter) for input messages that are received by the Prediction System 14, as discussed hereinabove.

The run-time process 104 includes a step 114 of receiving an input message or stream of input messages 26 (FIG. 1). As discussed hereinabove, the Prediction System 14 receives an input message or stream of input messages 26 in real-time. The received input messages 26 are messages on which predictions are to be performed.

The run-time process 104 also includes a step 116 of invoking or implementing machine learning models to perform predictions. According to an embodiment, the machine learning models are invoked or implemented using one or more of the adapters 32, 34, 36, depending on what kind of machine learning models are being invoked or implemented, as discussed hereinabove.

The run-time process 104 also includes a step 118 of performing predictions. As discussed hereinabove, the appropriate adapter loads the corresponding machine learning model for which the adapter is configured. According to an embodiment, the adapters are provided or loaded into the Production System 10 during an initialization of the Production System 10.

Once the appropriate adapter has loaded the corresponding machine learning model, the adapter sends input features (i.e., data fields) to the loaded machine learning model. The adapter performs predictions for the input messages 26 using the loaded machine learning model and based on the input features sent to the loaded machine learning model. The adapter then receives prediction value results (i.e. output) from the loaded machine learning model.

Prediction(s) for the input messages are performed by the Adapter(s) by using all of the invoked or implemented machine learning models configured in the Prediction System 14. All machine learning models that are used in the Production System 10 are loaded by their corresponding adapters in memory and thus the prediction results are obtained in real time. For each input message, a consolidated ensemble score is calculated, which is the final prediction score for that particular input message.

For example, assuming there are three different types of machine learning models configured into Prediction System 14 designed for performing risk analysis. For an incoming message into the prediction service, if the first machine learning model predicts the message as risky, the second machine learning model predicts the message as non-risky and the third machine learning model predicts the message as risky, ensemble techniques (e.g., majority voting and weighted averaging) can be applied, after which the final prediction for the message (e.g., risky) is attained.

The run-time process 104 also includes a step 122 of outputting the prediction results to the Prediction System 14. As discussed hereinabove, once the appropriate adapter receives a prediction value result (i.e. output) from its loaded machine learning model, the adapter sends the prediction value results to the Prediction System 14.

Once the Prediction System 14 receives the prediction value results from the adapters, the Prediction System 14 outputs the prediction value results 28.

It will be apparent to those skilled in the art that many changes and substitutions can be made to the embodiments described herein without departing from the spirit and scope of the disclosure as defined by the appended claims and their full scope of equivalents.

1. A production system for integrating machine learning models, comprising:
a Model Development System having at least one machine learning model stored therein, wherein the at least one machine learning model is configured to perform predictions on input data received by the at least one machine learning model;
a Prediction System configured to receive at least one input message and to generate at least one prediction result based on at least one prediction performed on input data from the at least one received input message; and
at least one machine learning model adapter coupled between the Model Development System and the Prediction System,
wherein the at least one machine learning model adapter is configured to load a corresponding machine learning model from the Model Development System,
wherein the at least one machine learning model adapter is configured to provide0 input data to the loaded machine learning model, wherein the input data is based on the at least one input message received by the Prediction System,
wherein the at least one machine learning model adapter is configured to receive prediction value results from the loaded machine learning model based on predictions performed by the loaded machine learning model, and
wherein the at least one machine learning model adapter is configured to send the prediction value results to the Prediction System,

2. The production system as recited in claim 1, further comprising at least one configuration file having configuration information associated with the at least one machine learning model stored in the Model Development System, wherein the at least one configuration file is selected by the Prediction System in real-time.

3. The production system as recited in claim 2, wherein the at least one configuration file is updated whenever a new machine learning model is stored in the Model Development System.

4. The production system as recited in claim 1, wherein the Prediction System is configured to receive a plurality of prediction value results from a corresponding plurality of machine learning model adapters, and wherein the Prediction System is configured to generate a consolidated prediction score based on the plurality of prediction value results.

5. The production system as recited in claim 1, wherein the Prediction System includes a common interface coupled to the at least one machine learning model adapter, wherein the at least one machine learning model receives input data based on the at least one input message received by the Prediction System via the common interface, and wherein the at least one machine learning model adapter sends the prediction value results to the Prediction System via the common interface.

6. The production system as recited in claim 1, wherein the at least one machine learning model adapter includes at least one of a Spark machine learning model adapter, a PMML machine learning model adapter or an H2O machine learning model adapter.

7. The production system as recited in claim 1, wherein the at least one machine learning model is saved in a format based on a platform of the Model Development System.

8. The production system as recited in claim 1, wherein the at least one machine learning model is built within the Model Development System.

9. The production system as recited in claim 1, wherein the at least one machine learning model is built external to the Model Development System, imported into the Model Development System and stored within the Model Development System.

10. The production system as recited in claim 1, wherein the Model Development System includes a model repository that stores the at least one machine learning model.

11. The production system as recited in claim 1, wherein the at least one machine learning model includes at least one of a Spark machine learning model, a PMML machine learning model or an H2O machine learning model.

12. A method for integrating machine learning models into a Production System, wherein the Production System includes a Model Development System and a Prediction System, the method comprising:
loading by at least one machine learning model adapter coupled between the Model Development System and the Prediction System a corresponding machine learning model from the Model Development System;
providing by the at least one machine learning model adapter input data to the loaded machine learning model, wherein the input data is based on at least one input message received by the Prediction System;
performing predictions by the loaded machine learning model on input data received by the loaded machine learning model from the at least one machine learning model adapter;
receiving by the at least one machine learning model adapter prediction value results from the loaded machine learning model based on predictions performed by the loaded machine learning model; and
sending by the at least one machine learning model adapter the prediction value results to the Prediction System.

13. The method as recited in claim 12, further comprising sending at least one configuration file by the Model Development System to the Prediction System, wherein the at least one configuration file includes configuration information associated with the at least one machine learning model stored in the Model Development System.

14. The method as recited in claim 13, further comprising updating the at least one configuration file whenever a new machine learning model is stored in the Model Development System.

15. The method as recited in claim 12, wherein the Prediction System receives a plurality of prediction value results from a corresponding plurality of machine learning model adapters, and wherein the Prediction System generates a consolidated prediction score based on the plurality of prediction value results.

16. The method as recited in claim 12, wherein the Prediction System includes a common interface coupled to the at least one machine learning model adapter, further comprising:
receiving by the at least one machine learning model input data based on the at least one input message received by the Prediction System via the common interface, and
sending by the at least one machine learning model adapter the prediction value results to the Prediction System via the common interface.

17. The method as recited in claim 12, further comprising building the at least one machine learning model external to the Model Development System, and importing the at least one machine learning model into the Model Development System.

18. The method as recited in claim 12, wherein the at least one machine learning model adapter includes at least one of a Spark machine learning model adapter, a PMML machine learning model adapter or an H2O machine learning model adapter.

19. The method as recited in claim 12, wherein the at least one machine learning model includes at least one of a Spark machine learning model, a PMML machine learning model or an H2O machine learning model.

20. The method as recited in claim 12, further comprising saving the at least one machine learning model in the Model Development System in a format based on a platform of the Model Development System.
